(19) United States
(12) Patent Application Publication
(10) Pub. No.: US 2011/0116386 A1
(43) Pub. Date: May 19, 2011

(54) TRANSMISSION CONTROL IN A WIRELESS COMMUNICATION SYSTEM

(75) Inventors: Scott David BLANCHARD, Mesa, AZ (US); John Scott SADOWSKY, Mesa, AZ (US)

(73) Assignee: GENERAL DYNAMICS C4 SYSTEMS, INC., Scottsdale, AZ (US)

(21) Appl. No.: 12/619,463

(22) Filed: Nov. 16, 2009

(51) Int. Cl. H04J 3/14; H04W 76/00

(52) U.S. Cl. 370/242; 370/329

(57) ABSTRACT

In a communication system that includes a control terminal (CT), a relay apparatus (RA), and a plurality user equipment (UE) that wirelessly communicate with the CT through the RA, a method for performing transmission control includes the CT receiving an RA-CT downlink signal that originated from a UE, determining a frequency-of-arrival (FoA) error from the RA-CT downlink signal (where the FoA error results at least in part from an error in a UE time reference with respect to a CT time reference), and providing, to the UE, a transmit frequency control (TFC) feedback signal that indicates the error in the UE time reference. The UE produces an adjusted UE uplink carrier frequency signal that compensates for the error in the UE time reference as indicated in the TFC feedback signal, and upconverts and transmits a UE-RA uplink signal using the adjusted UE uplink carrier frequency signal.

### GOVERNMENT LICENSE RIGHTS

The U.S. Government may have certain rights to some or all of the inventive subject matter of the present application as provided for by the terms of contract No. CP02H8901 (prime) and N00039-04-C-2009 (sub) awarded by the U.S. Navy.

### TECHNICAL FIELD

Embodiments generally relate to methods and apparatus for performing transmission control in a wireless communication system, and more particularly to methods and apparatus for performing transmit time control and/or transmit frequency control for radio frequency (RF) transmissions made by user equipment.

### BACKGROUND

In a typical multiple-access, wireless communication system, a plurality of mobile communication devices (“mobile devices”) may transmit information to and receive information from a single base station. In such a system, the “forward link” (i.e., the path from the base station to the mobile devices) is a one-to-many link, and the “reverse link” (i.e., the path from the mobile devices to the base station) is a many-to-one link. On the reverse link, signals from multiple mobile devices may simultaneously be received at the base station. Accordingly, the potential for multiple access interference exists.

In order to account for potential multiple access interference, orthogonal spreading codes may be implemented in a Code Division Multiple Access (CDMA) system. In a CDMA system, a group of mobile units may be assigned a common scrambling code and different spreading codes. The spreading code assignments are made to ensure that the signals received at the base station are substantially orthogonal when the signals are received in a time-aligned and time-synchronized manner. Accordingly, the base station may readily separate and de-spread the signals, and potential performance degradation due to multiple access interference may be averted. Because the forward link is a one-to-many link, time synchronization automatically is maintained because the base station may effectively be considered a single transmitter. However, on the reverse link, which is a many-to-one link, time synchronization between multiple mobile device signals is more difficult to achieve.

In a system in which signals between a mobile unit and a base station may travel along two or more paths (i.e., a “multipath channel”), components of the signal may arrive at the base station out of phase with each other, giving rise to multipath interference. “Delay spread” refers to the difference between various delays that affect a transmitted signal in a multipath channel environment. For example, in terrestrial cellular systems, the signaling delays between mobile units and a base station may be relatively short, although relatively wide delay spreads may be common due to multiple signaling paths that a signal may take in the presence of buildings, ground clutter, and so on. Conversely, in a satellite-based cellular system (e.g., a system in which the base station is located in a satellite), relatively narrow delay spreads may be experienced, even though the actual signaling delay between the mobile device and the base station is significantly longer than signaling delays in a terrestrial cellular system. The technique of using orthogonal spreading codes is effective in systems characterized by relatively narrow signaling delay spreads. However, in a system characterized by relatively wide delay spreads, the technique of using orthogonal spreading codes becomes relatively less robust.

In some systems, a “multi-user detection” (MUD) procedure may be performed at the base station in order to mitigate the potential for multiple access interference, rather than using orthogonal spreading codes. MUD is a signal processing technique that may be more robust in the presence of wider delay spreads. However, MUD procedures tend to be computationally intense, and they may impose substantial processing burdens at the base station.

Accordingly, what are needed are methods and apparatus for communicating between mobile units and base stations in a manner that avoids performance degradation due to multiple access and multipath interference. Desirably, these methods and apparatus will be adapted to perform robustly even when faced with relatively wide signaling delay spreads, and the methods may be implemented without imposing substantial processing burdens at the base station. Other features and characteristics of the inventive subject matter will become apparent from the subsequent detailed description and the appended claims, taken in conjunction with the accompanying drawings and this background.

### BRIEF DESCRIPTION OF THE DRAWINGS

The inventive subject matter will hereinafter be described in conjunction with the following drawing figures, wherein like numerals denote like elements, and

FIG. 1 is a simplified block diagram of a wireless communication system, in accordance with an example embodiment;

FIG. 2 is a simplified block diagram of a portion of user equipment, in accordance with an example embodiment;

FIG. 3 is a simplified block diagram of a portion of a control terminal, in accordance with an example embodiment;

FIG. 4 is a flowchart of a method for performing transmit time control and transmit frequency control in a wireless communication system, in accordance with an example embodiment; and

FIG. 5 is a flowchart of a method for initializing and updating transmit time control and transmit frequency control in a wireless communication system, according to an embodiment.

### DETAILED DESCRIPTION

The following detailed description of the inventive subject matter is merely exemplary in nature and is not intended to limit the inventive subject matter or the application and uses of the inventive subject matter. Furthermore, there is no intention to be bound by any theory presented in the following detailed description.

Embodiments include methods and apparatus for performing transmit time control (TTC) and transmit frequency control (TFC) in a wireless communication system. More particularly, embodiments include methods and apparatus for communicating between mobile units (e.g., user equipment or UE) and control terminals in a manner that may avoid performance degradation due to multiple access interference. Embodiments of the methods and apparatus described herein may be adapted to perform robustly even when faced with relatively long signaling delays, and the methods may be implemented without imposing substantial processing burdens at a control terminal.

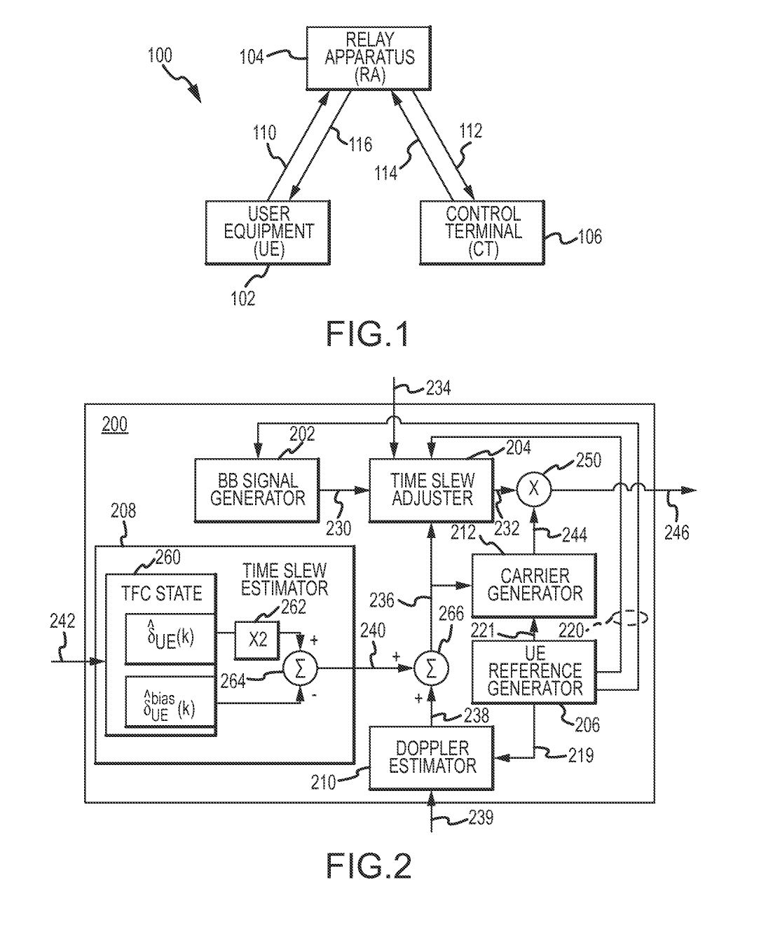

FIG. 1 is a simplified block diagram of a wireless communication system 100, in accordance with an example embodiment. A system (e.g., system 100) in which embodiments may be implemented include, but are not limited to, currently existing or future wireless communication systems that support a TDD mode, a wideband code division multiple access (W-CDMA) system, a UMTS-TDD (Universal Mobile Telecommunications System-Time Division Duplex) system that supports a TD-CDMA (Time Division CDMA) air interface, a TD-SCDMA (Time Division Synchronous CDMA) system, a system that supports CDMA2000, a wireless local area network (WLAN), a WiMAX (Worldwide Interoperability for Microwave Access) system (e.g., an IEEE 802.16 WiMAX system), and/or a half-duplex packet mode network based on carrier sense multiple access (e.g., 2-wire or hubbed Ethernet). System 100 may communicate based on proprietary, existing, and/or emerging standards or protocols, such as, for example but not by way of limitation, Interim Standard 95 (IS-95), an IEEE (Institute of Electrical and Electronics Engineers) 802.16 standard (WiMAX, MIMO-WiMAX (Multiple-Input, Multiple-Output WiMAX)), an IEEE 802.11a, g, and/or n standard (WLAN, MIMO-WLAN), an ETSI (European Telecommunications Standards Institute) BRAN HiperLAN 2 standard, a DVB standard, a WLAN standard, WNW (Wideband Networking Waveform) standard, a MIMO-OFDM standard, and/or other standards or proprietary protocols.

System 100 includes one or more wireless communication devices 102 (referred to below also as user equipment or “UE”), relay apparatus 104 (referred to below also as “RA”), and control terminal 106 (referred to below also as “CT”). Although only one UE 102, RA 104, and CT 106 are illustrated in FIG. 1 for purposes of simplicity, it is to be understood that system 100 may include a plurality of UEs, RAs, and/or CTs.

UE 102 may include any one or more devices adapted to transmit radio signals that are intermediately or finally destined for CT 106, and to receive radio signals originating from or routed by CT 106 toward the UE 102. Each UE 102 may be a mobile, portable or stationary device, including but not limited to a device selected from a group of devices that includes a cellular telephone, a radio, a software defined radio (“SDR radio”), a pager, a personal data assistant, a computer (e.g., a laptop or desktop computer), a network transceiver, an unmanned autonomous vehicle, a vehicle-borne transceiver (e.g., a motor vehicle, ship, submarine or aircraft-borne radio), and/or another type of wireless transceiver.

In an embodiment, UE 102 and CT 106 are adapted to communicate indirectly with each other through one or more RA 104. More particularly, a UE 102 may transmit signals to CT 106 over a UE-CT link, which includes a UE-RA uplink 110 between the UE 102 and RA 104, and a RA-CT downlink 112 between RA 104 and CT 106. Similarly, CT 106 may transmit signals to a UE 102 over a CT-UE link, which includes a CT-RA uplink 114 and an RA-UE downlink 116. Links 110, 116 may be referred to collectively as “UE-RA” links, and links 112, 114 may be referred to collectively as “CT-RA” links. According to an embodiment, communications over both UE-RA links 110, 116 are performed in the ultra high frequency (UHF) band (e.g., from 300 Megahertz (MHz) to 3 Gigahertz (GHz)), and communications over both CT-RA links 112, 114 are performed in the Ka band (e.g., from 26.5 GHz to 40 GHz). Accordingly, a UE-CT link (which includes UE-RA uplink 110 and RA-CT downlink 112) and a CT-UE link (which includes CT-RA uplink 114 and RA-UE downlink 116) each include a path segment that supports communications in the UHF band and a path segment that supports communications in the Ka band. As will be described in more detail later, RA 104 performs frequency translations from the Ka band to the UHF band (and vice versa), and errors in the RA clock may result in errors in the Ka band-to-UHF band translation. In the description below, reference may be made to the UHF band in conjunction with UE-RA links 110, 116 and to the Ka band in conjunction with CT-RA links 112, 114. It is to be understood that reference to UHF and Ka bands is not meant to limit application of the various embodiments to systems in which these bands are supported on the UE-RA links and the CT-RA links, respectively. In contrast, either the UE-RA and/or the CT-RA links may support communications in frequency bands other than the UHF and Ka bands, according to other embodiments.

Essentially, RA 104 is adapted to function as a “bent pipe” for radio signals communicated between UE 102 and CT 106. The term “relay apparatus” (RA) is used for example purposes only, and the term is not meant to limit RA 104 to a particular type of electronic device. In an embodiment, RA 104 may include at least one satellite-borne or terrestrial-based transmitter-receiver, transceiver, transponder, or repeater. In a more particular embodiment, RA 104 includes a transponder borne by a geostationary satellite (i.e., a satellite following a geostationary orbit). The transponder is adapted to receive UHF radio signals from UE 102 over link 110, to filter, amplify, and otherwise process the signals in the analog and/or digital domain, and to perform a UHF-to-Ka band frequency translation, thus producing Ka-band radio signals, which RA 104 transmits over link 112 to CT 106. In the particular embodiment just described, the transponder of RA 104 is further adapted to receive a Ka-band radio signal over link 114 from CT 106, to filter, parse, route, amplify, and otherwise process the signal in the analog and/or digital domain, and to perform a Ka-to-UHF band frequency translation, thus producing UHF radio signals that RA 104 transmits over link 116 to UE 102. In other embodiments, RA 104 may be borne by a type of mobile platform other than a geostationary satellite, such as a satellite following a low-Earth orbit, a medium-Earth orbit, a Molniya orbit, a satellite following another type of geosynchronous orbit, an aircraft, a balloon, a motor vehicle, a ship or a submarine, for example. Either way, system 100 is characterized in that RA 104 and CT 106 are in motion relative to each other. Although only one RA 104 is illustrated in FIG. 1, it is to be understood that, in other embodiments, information may be communicated between UE 102 and CT 106 through a relay apparatus network that includes one or more satellite-borne and/or terrestrial based relay apparatus adapted to communicate with each other and with UE 102 and CT 106. In still another embodiment, UE 102 and CT 106 may be adapted to communicate directly with each other without any intervening relay apparatus.

In an embodiment, information communicated between UE 102 and CT 106 is packetized into fixed-length or variable-length data frames prior to transmission. UE 102 and CT 106 each maintain a transmit clock and a receive clock, in an embodiment. Among other things, the transmit clock indicates the beginning and the end of a transmit portion of a frame (e.g., the start time of a first transmit slot and the end time of a last transmit slot), and the receive clock indicates the beginning and the end of a receive portion of a frame (e.g., the start time of a first receive slot and the end time of a last receive slot). According to an embodiment, CT 106 has access to a master time reference (e.g., a Global Positioning System (GPS) time reference or some other time reference, referred to herein as the “CT reference time”). The master time reference also may be used to provide a master frequency reference. Therefore, CT 106 may be considered to have access to an error-free, master reference signal (e.g., a master time reference signal and a master frequency reference signal). In contrast, clock errors (relative to the master reference signal) may be present in the clock signals of UE 102 and RA 104, as will be described in more detail below. As used herein, “clock errors” at the UE 102 and the RA 104 refer to differences between the UE or RA clock signals and the CT's master time reference.

In an embodiment, each UE 102 is responsible for transmitting (“TX”) a data-bearing radio signal or data burst (“UE TX burst”) at a proper transmit start time within a frame time so that the UE TX burst arrives at the CT 106 when the CT 106 expects it to arrive. However, the timing of radio signals communicated between UE 102 and CT 106 are affected by a signal propagation time (or “propagation delay”), among other things. Signal propagation time is a function of the radio wave propagation velocity through the air interface, the physical distance between the UE 102 and the CT 106 (e.g., through RA 104), and other system-added processing delays. Propagation delays between UE 102 and CT 106 may be considered to be relatively short, for example, when the frame duration is long compared with the propagation delay. In contrast, propagation delays between UE 102 and CT 106 may be considered to be relatively long, for example, when the frame duration is short compared with the propagation delay. Different propagation delays for different UE 102 are accounted for in attempting to achieve time-aligned, received signals at CT 106, according to an embodiment.

In addition to accounting for signal propagation time, embodiments include accounting for several frequency error sources that may inherently exist in system 100. For example, frequency error sources may include Doppler shifts on the links 110, 116 between UE 102 and RA 104, as well as Doppler shifts on the links 112, 114 between CT 106 and RA 104. In addition, and as mentioned previously, UE 102 and RA 104 each may have clock errors, with respect to the master reference signal generated at CT 106. A transmit frequency error also may be present in uplink signals transmitted on the CT-RA link 114. Frequency errors also may be imposed by the frequency translations performed by RA 104 (e.g., from UHF-to-Ka band, and vice versa). As will be described in more detail below, embodiments include estimating the inherent propagation delays, Doppler shifts, clock errors, and/or transmit frequency errors in system 100, and adjusting the transmit timing and/or transmit frequency of each UE 102 so that all of the UE signals received at CT 106 should be substantially time-aligned, relative to each other.

Before describing the various embodiments in detail, a brief explanation of Doppler will be given for background purposes and for enhanced understanding of the notations used herein. Doppler is a time skew that occurs due to relative motion between a transmitter and a receiver (e.g., between UE 102 and RA 104 and/or between CT 106 and RA 104). The transmitter transmits a signal, x(t), and the receiver receives a signal, y(t)=x(t−τ(t)). With accelerations neglected, one may write τ(t)=τ₀−δt, where τ₀=r₀/c is the t=0 delay due to a transmit-receive range of r₀, and δ=v₀/c, where v₀ is the closing range rate. Since t−τ(t)=t−(τ₀−δt)=(1+δ)t−τ₀, we have y(t)=x((1+δ)t−τ₀).

For a bandpass signal, x(t)=x_{BB}(t)exp(j2πf₀t), it follows that:

y(t)=x((1+δ)t−τ₀)=x_{BB}((1+δ)t−τ₀)exp(j2πf₀[(1+δ)t−τ₀]). (Equation 1)

The Doppler frequency shift is f_{D}=δf₀. In the below description, Doppler and time slew are tracked via a single parameter, δ. δ is a unitless quantity (measured in ppm) that is independent of carrier frequency. The phase term is φ=−2πf₀τ₀, which is treated as an unknown phase that is absorbed into the channel phase and generally ignored. Thus, the net effect of Doppler may be characterized as:

y(t)=x_{BB}((1+δ)t−τ₀)exp(j{2π(1+δ)f₀t+φ}), (Equation 2)

which encompasses a frequency shift, δf₀, on the carrier, and a baseband delay, τ₀, and a baseband time slew, (1+δ)t.

The following notation will be used throughout the remainder of this description:

f_{Ka}^{nom} refers to a nominal Ka band carrier frequency (e.g., for a particular beam);

f_{Ka} refers to a Ka band carrier frequency transmitted by the CT;

Δf_{Ka} refers to an uplink (UL) Ka band transmit frequency error;

f_{UL} refers to a nominal UHF UL carrier frequency;

f_{DL}, refers to a nominal UHF downlink (DL) carrier frequency;

δ_{Ka} refers to Doppler shift for the CT-RA link (e.g., in the Ka band);

δ_{UHF} refers to Doppler shift for the UE-RA link (e.g., in the UHF band);

δ_{RA} refers to RA clock error;

δ_{UE} refers to UE clock error;

\hat{δ}_{UE} refers to an estimate of the UE clock error;

\hat{δ}_{RA} refers to an estimate of the RA clock error;

\hat{δ}_{Ka} refers to an estimate of the Doppler shift for the CT-RA link; and

\hat{δ}_{UE}^{bias} refers to a constant bias correction term.

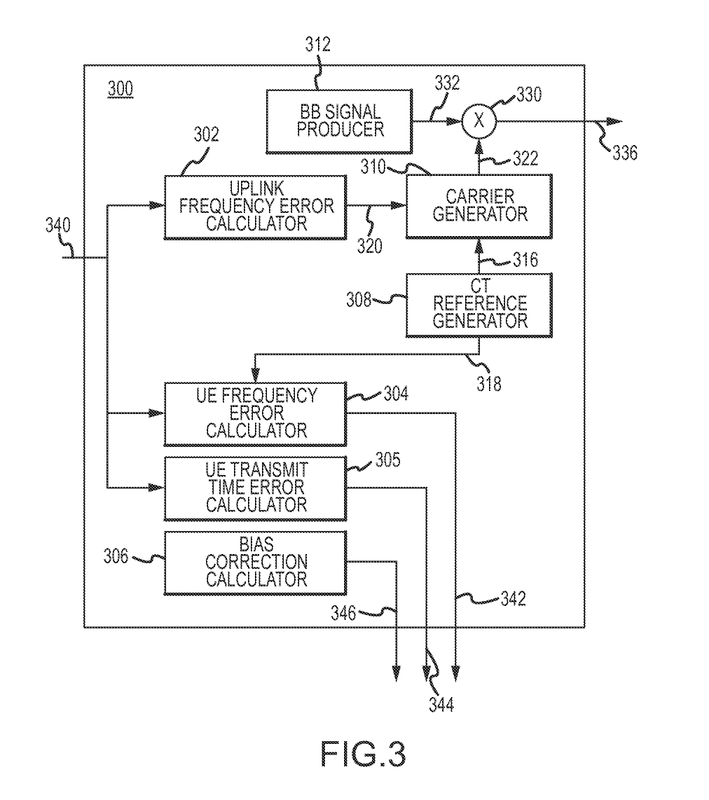

The various embodiments will now be described in more detail. First, embodiments of a UE (e.g., UE 102, FIG. 1) and a CT (e.g., CT 106, FIG. 1) will be described in conjunction with FIGS. 2 and 3. More particularly, FIG. 2 is a simplified block diagram of a portion of a UE 200 (e.g., UE 102, FIG. 1), in accordance with an example embodiment. According to an embodiment, UE 200 is adapted to perform transmit time control and transmit frequency control of signals transmitted by the UE 200 in order to ensure that the signals transmitted by UE 200 will be received at a CT (e.g., CT 106, FIG. 1) time aligned with other UEs that are communicating with the CT using the same carrier frequency. FIG. 2 illustrates functional blocks associated with TTC and TFC, and for simplicity purposes, does not illustrate functional blocks associated with other UE functions (e.g., user interfaces, other transceiver components, power management components, and so on).

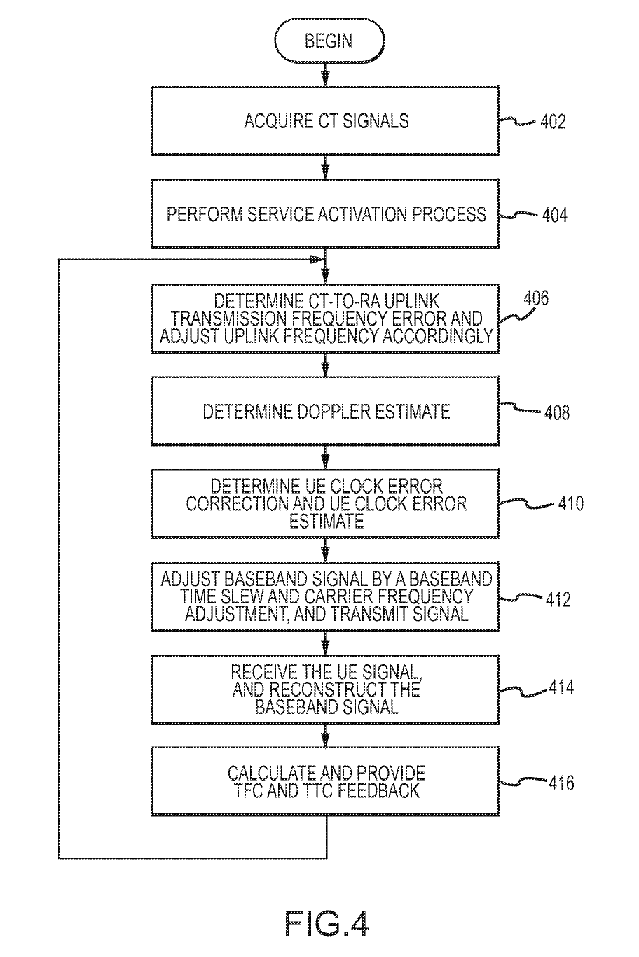

According to an embodiment, UE 200 includes a baseband (BB) signal generator 202, time slew adjuster 204, UE reference generator 206 (e.g., the UE clock), time slew estimator 208, Doppler estimator 210, and carrier generator 212, among other functional blocks that will be discussed in more detail below. UE reference generator 206 is adapted to produce signals 219, 220, 221 (e.g., oscillator signals and/or clock signals), which are used by various functional blocks (e.g., blocks 202, 204, 210, and 212) to control the timing of procedures performed by those functional blocks. Essentially, the UE reference generator 206 functions to provide a UE time reference. As will be discussed in more detail in conjunction with FIG. 4 later, the signals 219-221 include a clock error, δ_{UE}, with respect to the CT reference signal (e.g., CT 106, FIG. 1). According to an embodiment, the CT (e.g., CT 106) and UE 200 cooperate in attempting to determine an estimate of the clock error, \hat{δ}_{UE}, and UE 200 compensates for the actual clock error using the estimated clock error. For example, as will be described in more detail below, carrier generator 212 produces a carrier frequency signal 244, which is adjusted based on UE clock error estimates (and Doppler estimates), and time slew adjuster 204 produces a baseband signal 232, which is adjusted in time based on the UE clock error estimates.

In the embodiment illustrated in FIG. 2, UE reference generator 206 may include a non-tunable (e.g., non-adjustable) type of oscillator or clock. For example, the UE reference generator 206 may include a crystal oscillator, and accordingly, the UE's reference frequency is the oscillation frequency of the crystal. In an alternate embodiment, the UE reference may be tunable (e.g., the UE reference generator may include a voltage controlled oscillator (VCO) or a numerically controlled oscillator (NCO)). In the latter embodiment, reference and clock adjustments may be made to affect the carrier and chip timing. Although an embodiment in which a non-tunable reference generator is implemented is discussed in detail below, embodiments are intended to include both tunable and non-tunable UE reference generators.

BB signal generator 202 is adapted to generate a baseband signal 230, which is intended for transmission. As indicated above, the baseband signal 230 may be packetized into fixed-length or variable-length data frames. Time slew adjuster 204 is adapted to determine a time slew to be applied to the baseband signal 230, and to apply the time slew to the baseband signal 230, in order to produce a time-adjusted baseband signal 232. According to an embodiment, the time slew may be determined based on information contained within a TTC feedback signal 234 and an internally-generated adjustment signal 236. The TTC feedback signal 234 is received from the CT (e.g., CT 106, FIG. 1), and CT generation of the TTC feedback signal 234 will be discussed in more detail in conjunction with FIGS. 3 and 4, later.

As will also be discussed in more detail in conjunction with FIG. 4, later, the internally-generated adjustment signal 236 is generated based on a combination of a Doppler estimation signal 238 (produced by Doppler estimator 210) and time slew signal 240 (produced by time slew estimator 208). The Doppler estimation signal 238 is produced based on a frequency estimation of a downlink signal 239, such as a transmitted reference signal from the CT, according to an embodiment (e.g., a common pilot signal (e.g., a Common Pilot Channel (CPICH) signal in a WCDMA system)). The time slew signal 240 is produced based on information contained within a TFC feedback signal 242 from the CT (e.g., CT 106, FIG. 1). CT generation of the TFC feedback signal 242 will be discussed in more detail in conjunction with FIGS. 3 and 4, later.

The time-adjusted baseband signal 232 produced by time slew adjuster 204 is up-converted (e.g., by up-converter block 250) based on a carrier frequency signal 244 produced by carrier generator 212. Carrier generator 212 produces the carrier frequency signal 244 based on the UE clock signal 221 and the internally-generated adjustment signal 236. According to an embodiment, the carrier frequency signal 244 has a frequency in the UHF band, although the carrier frequency signal 244 may have a frequency outside the UHF band, in other embodiments. The result of the up-conversion process is an uplink signal 246, which may thereafter be transmitted by the UE 200 to the CT (e.g., CT 106, FIG. 1) via an RA (e.g., RA 104, FIG. 1). As the above description indicates, the uplink signal 246 represents a signal transmitted at a time and frequency that have been adjusted by a baseband time slew and a carrier frequency adjustment, in order to compensate for various, inherent frequency error sources in the system. As will be explained in more detail below, implementation of an embodiment results in an uplink signal 246 that should be received by the CT time aligned with signals produced by other UE that are communicating at the same carrier frequency, according to an embodiment.

FIG. 3 is a simplified block diagram of portions of a CT 300 (e.g., CT 106, FIG. 1), in accordance with an example embodiment. According to an embodiment, CT 300 is adapted to perform various functions associated with providing the UE with information that enables the UE to perform TTC and TFC of signals transmitted by the UE (e.g., UE 102, FIG. 1 or UE 200, FIG. 2). In addition, CT 300 is adapted to determine and correct for a CT-RA uplink transmission frequency error, as will be described below. FIG. 3 illustrates functional blocks associated with TTC, TFC, and uplink frequency error compensation, and for simplicity purposes, does not illustrate functional blocks associated with other CT functions.

According to an embodiment, CT 300 includes an uplink frequency error calculator 302, a UE frequency error calculator 304, a UE transmit time error calculator 305, a bias correction calculator 306, a CT reference generator 308, a carrier generator 310, and a BB signal producer 312. According to an embodiment, CT 300 includes a bank of UE receivers, where a particular receiver is dedicated to each UE that is communicating with CT 300. The illustrated UE frequency error calculator 304, UE transmit time error calculator 305, and bias correction calculator 306 represent functional components of a single one of the UE receivers. Although only a single one of each of these functional components is illustrated for purposes of simplicity, multiple instantiations of these functional components may be implemented in conjunction with the multiple UE receivers.

CT reference generator 308 is adapted to produce clock signals 316, 318, which may be used by various other functional blocks (e.g., blocks 304, 310). As indicated previously, the CT reference generator 308 has access to a master time reference (e.g., a GPS time reference or some other time reference), in an embodiment, and therefore the clock signals 316, 318 generated by CT reference generator 308 may be considered to be error free. Essentially, the CT reference generator 308 functions to provide a CT time reference.

One function performed by CT 300 is to adjust the CT's uplink transmission frequency (i.e., the frequency of signals transmitted on CT-RA uplink 114, FIG. 1) to pre-compensate for CT-RA link Doppler shifts, and also to correct for RA frequency translation errors due to RA clock errors (e.g., errors in an RA time reference). The CT uplink transmission frequency adjustments are common to all UE signals. According to an embodiment, the CT uplink transmission frequency adjustment function is carried out essentially by uplink frequency error calculator 302 and carrier generator 310. According to an embodiment, the RA (or other components of a mobile platform that carries the RA) may transmit information (e.g., telemetry), which uplink frequency error calculator 302 may use to determine CT-RA link Doppler estimate and RA clock error. Based on the determined CT-RA link Doppler estimate and the RA clock error, uplink frequency error calculator 302 is adapted to determine a CT-RA uplink transmission frequency error, Δf_{Ka}, as will be described in more detail in conjunction with FIG. 4. According to an embodiment, uplink frequency error calculator 302 is adapted to cause the CT's uplink transmission frequency to be adjusted in order to compensate for the uplink transmission frequency error. For example, this may include the uplink frequency error calculator 302 providing an indication of the calculated error via a control signal 320 to carrier generator 310.

Carrier generator 310 produces a carrier frequency signal 322 based on the control signal 320 and a CT clock signal 316 produced by CT reference generator 308. According to an embodiment, the carrier frequency signal 322 has a frequency in the Ka band, although the carrier frequency signal 322 may have a frequency outside the Ka band, in other embodiments. The carrier frequency signal 322 is combined (e.g., by combiner 330) with a baseband signal 332 produced by BB signal producer 312, in order to generate an uplink signal 336, which may thereafter be transmitted by the CT 300 to a UE (e.g., UE 102, FIG. 1) via an RA (e.g., RA 104, FIG. 1). As the above description indicates, the uplink signal 322 represents a signal transmitted at a frequency that has been adjusted based on an estimate of the uplink transmission frequency error, Δf_{Ka} (e.g., based on the CT-RA link

### Doppler Estimate and the RA Clock Error Estimate).

In addition to adjusting the CT-RA uplink carrier frequency, CT 300 also performs the function of determining the frequency error within each UE-RA-CT signal, and providing an indication of the UE frequency error to the UE which transmitted the signal (e.g., via a TFC feedback signal 342). Since the CT 300 has pre-compensated for CT-RA Doppler and RA frequency translation error (due to RA clock error), the frequency error of each signal arriving at a UE is a function primarily of RA-UE Doppler (i.e., Doppler on the RA-UE downlink 116, FIG. 1). Accordingly, and as discussed previously in conjunction with FIG. 2, the UE can estimate the Doppler on the RA-UE downlink, and use the estimate to pre-correct signals transmitted by the UE on the UE-RA uplink (e.g., UE-RA uplink 110, FIG. 1). This effectively eliminates Doppler effects on the UE-RA uplink from signals transmitted by the UE. However, the UE Doppler estimation may be inaccurate due to the UE clock error, δ_{UE}, since the Doppler estimate generated by the UE is produced using to the UE clock (e.g., UE reference generator 206, FIG. 2). The result is that the corrected UE-RA uplink carrier frequency has a frequency error proportional to about two times the UE clock error.

According to an embodiment, UE frequency error calculator 304 receives the downlink signal 340 and the clock signal 318 produced by CT reference generator 308, and based on frequency-of-arrival (FoA) measurements of the downlink signal 340, determines the remaining frequency error of the downlink signal 340 (which error is assumed to be proportional to about two times the UE clock error). Calculation of the frequency error will be described in more detail in conjunction with FIG. 4. According to an embodiment, the downlink signals 340 used to measure the frequency error may include Random Access Channel (RACH) messages.

UE frequency error calculator 304 calculates an estimate of the UE clock error, \hat{δ}_{UE}, from the measured UE frequency error. In addition, UE frequency error calculator 304 is adapted to provide a UE clock error correction value, Δ_{TFC}(k), to the UE in the form of a TFC feedback signal 342, where the UE clock error correction value represents the calculated UE clock error. The UE clock error correction values, Δ_{TFC}(k), may be provided, for example, in messages sent via the RACH or a dedicated control or pilot channel (e.g., a Dedicated Physical Control Channel (DPCCH) in a WCDMA system), according to an embodiment, and as will be described in more detail later.

CT 300 also performs the function of determining the transmit time error for each UE with which CT 300 is communicating, and providing an indication of the transmit time error to each UE (e.g., via a TTC feedback signal 344). As will be discussed in more detail later, UE transmit time error calculator 305 is adapted to determine estimates of the transmit time errors in the downlink signal 340 (e.g., due to the Doppler on the UE-RA and RA-CT links, among other things). In addition, UE transmit time error calculator 304 is adapted to provide corresponding UE transmit time correction values, Δ_{TTC}(k), to the UE in the form of a TTC feedback signal 344. According to an embodiment, the UE transmit time error estimates are determined based on time-of-arrival (ToA) measurements of the received downlink signals 340. The UE transmit time correction values, Δ_{TTC}(k), may be provided, for example, in messages sent via the RACH or a dedicated channel (e.g., a DPCCH), according to an embodiment, and as will be described in more detail later.

Finally, bias correction calculator 306 is adapted to determine a constant bias correction term 346, \hat{δ}_{UE}^{bias}, and to transmit the constant bias correction term to the UE (e.g., via the RACH, a Broadcast Control Channel (BCCH), or a Dedicated Control Channel (DCCH)), according to an embodiment.

FIG. 4 illustrates a flowchart of a method for establishing communications between a UE (e.g., UE 102, FIG. 1) and a CT (e.g., CT 106, FIG. 1), and performing transmit time control and transmit frequency control in a wireless communication system, in accordance with an embodiment. For enhanced understanding, FIG. 4 should be viewed in conjunction with FIGS. 2 and 3, which were discussed above. The method may begin, in block 402, by the UE acquiring and tracking certain signals that are transmitted by the CT on common channels (e.g., primary (P) and/or secondary (S) synchronization (SCH) channels, a common pilot channel (e.g., a CPICH), and a broadcast channel). A common pilot channel may be used by the UE, for example, for timing and phase estimations, which enable the UE to remain synchronized with the CT signals.

In block 404, when the UE intends to establish two-way communications with the CT, the UE initiates performance a service activation process. The service activation process may include a process for determining the propagation delay for radio signals exchanged between the UE and the CT. Knowledge of the propagation delay enables the UE to transmit future signals in a time-synchronized manner. Determination of the propagation delay may include the exchange of a sequence of signals. According to an embodiment, determining the propagation delay includes the UE sending a first signal (e.g., a Random Access Channel (RACH) message) to the CT at a first time, the CT detecting the signal at a second time, the CT sending a message to the UE (e.g., on a Forward Access Channel (FACH)) that indicates the second time (e.g., the ToA of the signal at the CT), and the UE receiving the message at a third time. The CT also may send a message to the UE indicating a frequency of arrival (FoA) of the signal. According to an embodiment, the CT may include a special RACH message receiver, which can detect a RACH with an arbitrary delay. The one-way propagation delay may be determined to be approximately equal to the difference between the first time and the second time, according to an embodiment. In addition or alternately, the two-way propagation delay may be determined to be approximately equal to twice the one-way propagation delay, in an embodiment. In an alternate embodiment, the two-way propagation delay may be determined to be approximately equal to the difference between the first time and the third time.

According to an embodiment, once the propagation delay is determined, the CT and the UE exchange information indicating the one-way or two-way propagation delay. In a particular embodiment, this information is sent as a message by the CT to the UE. In an alternate embodiment, the UE may determine the one-way and/or two-way propagation delay using a method analogous to that described above, and the UE may send the propagation delay information to the CT. The propagation delay information may include a value indicating the actual one-way or two-way propagation delay as calculated by the CT or the UE (e.g., a value expressed in milliseconds), according to an embodiment, or the propagation delay information may include other types of information that enables a determination of the one-way or two-way propagation delay (e.g., the first, second, and/or third times discussed in the previous paragraph, an encoded value indicating the propagation delay, a slot offset corresponding to the propagation delay, or some other value).

As mentioned previously, the CT-UE transmission includes several frequency error sources, including Doppler on the CT-RA link (e.g., link 114, FIG. 1), a frequency translation (e.g., from Ka band to UHF band) at the RA, RA clock error, and Doppler on the RA-UE link (e.g., link 116, FIG. 1). In order to at least partially compensate for these frequency error sources, the CT determines an uplink transmission frequency error (e.g., an error in the CT-RA link 114) and, accordingly, makes a fine adjustment to its uplink transmission frequency, in block 406. The net result of this adjustment is that the downlink signals received by UE 204 (e.g., signals received on link 116, FIG. 1) appear as if they are transmissions purely within the frequency band supported on that link (e.g., pure UHF transmissions). In addition, the adjustment mitigates the effect of the RA clock error.

According to an embodiment, the CT maintains estimates of the RA clock error, \hat{δ}_{RA}, and estimates of the Doppler on the CT-RA links (e.g., links 112, 114, FIG. 1), \hat{δ}_{Ka}. According to an embodiment in which the RA is satellite borne, the Doppler estimate, \hat{δ}_{Ka}, may be calculated, for example, from ephemeris data of the satellite. The RA clock error estimate, \hat{δ}_{RA}, may be determined by measuring the RA-CT downlink frequency error and subtracting the Doppler estimate, in order to produce an estimate of the RA clock error. In an alternate embodiment, the RA clock error and/or the Doppler on the CT-RA links may be obtained from a separate telemetry link. The CT-RA uplink transmission frequency, f_{Ka} (e.g., the frequency of signals transmitted on link 114, FIG. 1), may be defined by the following equation:

$${f}_{Ka} = {f}_{DL} - \frac{1 + {\hat{δ}}_{RA}}{1 + {\hat{δ}}_{Ka}} ( {f}_{DL} - {f}_{Ka}^{nom} ) + Δ {f}_{CT} , \qquad ( Equation 3 )$$

where the error term, Δf_{CT}, may be present due to the implementation of a frequency error correction methodology performed at the CT. According to an embodiment, the CT performs a common frequency error correction for all subcarriers, and Δf_{CT} results from differential Doppler across the subcarriers. The frequency error, Δf_{CT}, may result in a time drift that is common to all UEs served by the same CT-UE carrier. Δf_{CT} may be the largest contributor to the common time drift bias, although a common time-of-arrival (ToA) drift is not likely to destroy orthogonality between signals received at the CT, in an embodiment. In embodiments that use different frequency error correction methodologies, Δf_{CT} may not be a factor.

According to an embodiment, the CT transmission frequencies are selected so that the effect of RA clock error, δ_{RA}, is mitigated in the CT-UE transmission. Accordingly, the downlink signal as received by UE 202 may be defined as:

y_{DL}(t)=x_{BB}((1+δ_{Ka}+δ_{UHF})t−τ₀)exp(j{2π(1+δ_{Ka}+δ_{UHF})f_{DL}+Δf)t+φ}), (Equation 4)

where the frequency error, Δf, may be dominated by Δf_{CT}, and τ₀ is the CT-UE propagation delay (e.g., as determined in block 404). Having performed the CT-RA uplink transmission frequency adjustment, the frequency translation (e.g., from Ka band to UHF band) at the RA and the RA clock error may be sufficiently mitigated.

Referring again to FIG. 4, in block 408, the UE (e.g., Doppler estimator 210, FIG. 2) generates an estimate of the combined Doppler, \hat{δ}_{Dop}(t), on the CT-RA and RA-UE links (e.g., links 114, 116, FIG. 1), according to an embodiment. Due to the CT's uplink frequency adjustment (e.g., as performed in block 406), the combined Doppler estimation is directly related to the time slew of the received baseband signal at the UE. However, the Doppler measurement also may be corrupted by the UE clock error, δ_{UE}.

According to an embodiment, the Doppler estimation measures the difference between the received downlink frequency (e.g., the frequency of the signal received on link 116, FIG. 1) and the uncorrected UE reference frequency, (1+δ_{UE})f_{DL}. According to an embodiment, the received downlink frequency is derived from a transmitted reference signal, such as a common pilot signal (e.g., signal 239, FIG. 2), received on the downlink from the RA. From Equation 4, above, the output of the UE Doppler estimation, is \hat{δ}_{Dop}(t), may be defined as:

$${\hat{δ}}_{Dop} ( t ) = \frac{1}{{f}_{DL}} \{ ( 1 + {δ}_{Ka} + {δ}_{UHF} ) ( {f}_{DL} + Δ f ) - ( 1 + {δ}_{UE} ) {f}_{DL} + {ɛ}_{UE}^{freq} ( t ) \} , \qquad ( Equation 5 )$$

where (1+δ_{Ka}+δ_{UHF})(f_{DL}+Δf) is the receive frequency, (1+δ_{UE})f_{DL} is the UE reference frequency (downlink), and ε_{UE}^{freq}(t) is the error of the UE's frequency estimation algorithm. The time dependence in \hat{δ}_{Dop}(t) indicates that it is a dynamic estimate, and this estimate is periodically updated, according to an embodiment. According to a particular embodiment, the UE Doppler estimation is updated periodically each 10 milliseconds (ms), 20 ms, 40 ms or at some other periodic rate. Equation 5 may be simplified to:

\hat{δ}_{Dop}(t)=δ_{Ka}+δ_{UHF}−δ_{UE}+\tilde{δ}_{Dop}(t), (Equation 6)

where \tilde{δ}_{Dop}(t) are error terms. Equation 6 illustrates that, according to an embodiment, \hat{δ}_{Dop}(t) is a measurement of the combined CT-RA link and RA-UE link Doppler, δ_{Ka}+\hat{δ}_{UHF}, which is corrupted by the UE clock error, δ_{UE}. After eliminating negligible terms, the error term, \tilde{δ}_{Dop}(t), in Equation 6 may be defined as:

$${\tilde{δ}}_{Dop} ( t ) \approx \frac{Δ f + {ɛ}_{UE}^{freq} ( t )}{{f}_{DL}} , \qquad ( Equation 7 )$$

where the term,

$$\frac{Δ f}{{f}_{DL}} ,$$

represents the UE common bias error. The frequency estimation error term,

$$\frac{{ɛ}_{UE}^{freq} ( t )}{{f}_{DL}} ,$$

on the other hand, may be both fluctuating in time and independent across UEs. The frequency estimation error term may be referred to as a “per UE” error. As will be described below in conjunction with block 412, the Doppler estimate, \tilde{δ}_{Dop}(t), will be used in performing time slew and carrier adjustment.

In block 410, a UE clock error correction value, Δ_{TFC}(k), and dynamic estimate of the UE clock, \hat{δ}_{UE}(k), are determined, according to an embodiment. Referring also to FIGS. 2 and 3, values for the UE clock error correction may be determined by the CT (e.g., by UE frequency error calculator 304, FIG. 3), and provided to the UE via a TFC feedback signal (e.g., signal 242, FIG. 2 or signal 342, FIG. 3). As will be discussed in more detail later, the UE clock error correction may be determined based on CT measurements of downlink signals taken at CT time, tₖ, and applied at the UE at time tₖ+τ₀. According to an embodiment, the first UE clock error correction value, Δ_{TFC}(0), may be provided in a RACH response message, although the value may be provided in other messages, in other embodiments. Subsequent UE clock error correction values, Δ_{TFC}(k) for k>0, may be provided in a TFC feedback signal carried on a channel such as a dedicated channel (e.g., a DPCCH), according to an embodiment, although the subsequent UE clock error correction values may be provided on other types of channels, in other embodiments. According to an embodiment, the UE clock error correction values are provided periodically (e.g., every 600-800 msec, or at some other time interval), although the UE clock error correction values may be provided more or less frequently or aperiodically, in other embodiments.

As discussed previously, the UE performs a process of correcting for RA-UE Doppler (i.e., Doppler on the RA-UE downlink 116, FIG. 1), which process is corrupted by errors in the UE clock with respect to the CT master time reference. Accordingly, the corrected UE-RA uplink transmission frequency has a frequency error proportional to about two times the UE clock error. At the CT, the FoA of signals received from the UE (via the RA) are measured using frequency tracking algorithms, and the ToA of signals received from the UE are measured using time tracking algorithms. The FoA measurements are used for TFC feedback, Δ_{TFC}(k), and the ToA measurements are used for TTC feedback, Δ_{TTC}(k). According to an embodiment, the TTC feedback represents the difference between the actual (as measured) ToA and the time that the signal was ideally supposed to arrive at the CT, based on the CT clock, if synchronization were perfect. The FoA measurements are related to the rate of change of the ToA error (“time slewing”). The CT may send the FoA measurements to the UE via the TFC feedback, or the CT may convert the measurements to a delta, and send the delta to the UE, in various embodiments.

Upon receipt of the TFC feedback signal, the dynamic estimate of the UE clock error may be maintained in the UE by time slew estimator 208, for example, in the form of TFC state information 260. TFC state information 260 may include, for example, the dynamic estimate of the UE clock error, \hat{δ}_{UE}(k), and a bias correction term, \hat{δ}_{UE}^{bias}. According to an embodiment, the bias correction term is provided by the CT (e.g., CT 106, FIG. 1). The bias correction term may be communicated to the UE, for example, in a message communicated over a BCCH, a RACH, a DCCH, or via some other type of channel, according to various embodiments. The bias correction term is determined in a manner that is intended to correct common bias errors (e.g., Δf_{CT}). Bias correction may be implemented in the UE, according to the embodiments discussed in detail herein. In an alternate embodiment, bias correction may be implemented in the CT. Initially, the state of the dynamic estimate of the UE clock error is \hat{δ}_{UE}(0)=0, and the state update may be defined as:

\hat{δ}_{UE}(k)=\hat{δ}_{UE}(k−1)+Δ_{TFC}(k−1). (Equation 8)

According to an embodiment, the TFC feedback value, Δ_{TFC}(k−1), may be multiplied by a gain, g (e.g., 0.1<g<=1), although this is not essential.

In block 412, the baseband signal (e.g., signal 230, FIG. 2) is adjusted by a baseband time slew and a carrier frequency adjustment. According to an embodiment, the baseband time slew may be calculated by the time slew estimator 208. More specifically, a X2 factor may be applied (e.g., by multiplier 262, FIG. 2) to the UE clock error, \hat{δ}_{UE}(k), and a difference between the doubled UE clock error and the bias correction term, \hat{δ}_{UE}^{bias}, may be determined (e.g., by subtractor 264, FIG. 2), yielding the time slew signal (e.g., signal 240, FIG. 2). According to an embodiment, the X2 factor is applied in order to perform two UE clock corrections: 1) a correction to the UE clock error term in the Doppler estimate, \hat{δ}_{Dop} (t); and 2) a correction in the transmit clock reference. Accordingly, the total time slew and the Doppler correction to be applied by the UE (e.g., signal 236, FIG. 2) may be defined as:

\hat{δ}_{UE}^{total}(t)=\hat{δ}_{Dop}(t)+2\hat{δ}_{UE}(k)−\hat{δ}_{UE}^{bias}, (Equation 9)

according to an embodiment, where the sum of the Doppler correction (e.g., signal 238, FIG. 2) and the total time slew (e.g., signal 240, FIG. 2) may be determined by an adder (e.g., adder 266, FIG. 2) within the UE. More specifically, the baseband time slew applied (e.g., by time slew adjuster 204, FIG. 2) to the baseband signal (e.g., signal 230, FIG. 2) may be represented as 1−\hat{δ}_{UE}^{total}(t). The transmit carrier correction applied (e.g., by carrier generator 212, FIG. 2) to the carrier signal (derived from UE clock signal 221, FIG. 2) may be represented as −\hat{δ}_{UE}^{total}(t), and thus the UE carrier frequency may be represented as −\hat{δ}_{UE}^{total}(t)f_{UL}. Accordingly, the transmitted waveform (e.g., signal 246, FIG. 2) may be defined as:

x_{UL}(t)=x_{BB}((1−\hat{δ}_{UE}^{total}(t))(1+δ_{UE})texp(j2π[(1+δ_{UE})−\hat{δ}_{UE}^{total}(t)]f_{UL}t), (Equation 10)

where (1+δ_{UE})t is the uncorrected UE time reference.

After transmitting the UE signal (e.g., signal 246, FIG. 2), several time and frequency distortions affect the signal. These time and frequency distortions include, for example: 1) a time slew and Doppler frequency shift, δ_{UHF}, imposed by the UE-RA uplink (e.g., link 110, FIG. 1); 2) an RA clock error, δ_{RA}, which corrupts the RA's translation to baseband and sampling for the digitized RA-CT downlink (e.g., link 112, FIGS. 1); and 3) demodulation and reconstruction of an analog baseband signal by the CT. Regarding the last distortion, the analog reconstruction clock is slaved to the received symbol rate, which is a (1+δ_{Ka})(1+δ_{RA})t time reference due to the RA clock error and the RA-CT downlink Doppler. The RA sample clock may be represented as (1+δ_{RA})t, and the CT reconstruction clock may be represented as (1+δ_{Ka})(1+δ_{RA})t.

In block 414, the UE signal transmitted via the UE-RA uplink (e.g., link 110, FIG. 1) and the RA-CT downlink (e.g., link 112, FIG. 1) is received at the CT. From the received signal (e.g., signal 340, FIG. 3), the CT (e.g., CT 300, FIG. 3) produces a reconstructed baseband signal. After accounting for the time and frequency distortions discussed in the previous paragraph, the reconstructed baseband signal may be represented as:

y_{CT}(t)=x_{BB}([1+δ_{UE}−δ_{UHF}+δ_{Ka}−\hat{δ}_{UE}^{total}(t−τ₀)](t−τ₀))×exp(j2π{([1+δ_{UE}+δ_{UHF}−\hat{δ}_{UE}^{total}(t−τ₀)]−(1−τ_{RA}))f_{UL}(1+δ_{Ka})t+φ}), (Equation 11)

where τ₀ is the UE-CT transmission delay. By performing various cancellations, reductions, and substitutions of expressions from previous equations, the reconstructed baseband signal may alternatively be represented as:

y_{CT}(t)=x_{BB}([1−2\tilde{δ}_{UE}(k)−\tilde{δ}_{Dop}(t−τ₀)+\hat{δ}_{UE}^{bias}](t−τ₀))×exp(−j2π{[2\tilde{δ}_{UE}(k)+\tilde{δ}_{Dop}(t−τ₀)+δ_{Ka}+δ_{RA}−\hat{δ}_{UE}^{bias}]f_{UL}t+φ}), (Equation 12)

for tₖ₋₁+2τ₀<t<tₖ+2τ₀, since the TFC feedback Δ_{TFC}(k−1) applied at the UE at time tₖ₋₁+τ₀ to produce state \tilde{δ}_{UE}(k) and since this new TFC state is visible at the CT at time tₖ₋₁+2τ₀. The above equation assumes that: 1) negligible δ_{Ka}×δ terms are eliminated (e.g., indicating that the sample skew Doppler is negligible in the frequency term of Equation 11); 2) there is no Ka band Doppler frequency shift, δ_{Ka}f_{Ka}, in Equation 11, because the link is digital, according to an embodiment; and 3) the TTC feedback is neglected, as it is a delay adjustment in the baseband part that occurs on the boundary times tₖ+2τ₀.

In block 416, the CT calculates and provides the TFC feedback, Δ_{TFC}(k) (e.g., signal 242, FIG. 2 or 342, FIG. 3), and the TTC feedback, Δ_{TTC}(k) (e.g., signal 234, FIG. 2 or 344, FIG. 3). According to an embodiment, the TTC and TFC feedback values are determined by ToA and frequency measurements made in the CT, which are denoted Z_{τ}(k) and Z_{δ}(k), respectively. The CT makes a ToA error measurement at time tₖ for k>0, which measurement may be represented as:

z_{τ}(k)=τ(tₖ)+v_{τ}(k), (Equation 13)

where v_{τ}(k) is the CT ToA measurement error, having variance σ_{τ}². According to an embodiment, z_{τ}(k) may be measured in a rake receiver of the CT. From Equation 13, the CT frequency estimate may be determined as:

\hat{f}_{CT}(t)=[−2\tilde{δ}_{UE}(k)−\tilde{δ}_{Dop}(t−τ₀)−δ_{Ka}−δ_{RA}+\hat{δ}_{UE}^{bias}]f_{UL}+ε_{CT}^{freq}(t), (Equation 14)

for tₖ₋₁+2τ₀<t<tₖ+2τ₀, where ε_{CT}^{freq}(t) is the CT frequency estimation error. The CT measurement of \tilde{δ}_{UE}(k) calculated at time tₖ may be defined as:

$${z}_{δ} ( k ) = - \frac{{\hat{f}}_{CT} ( {t}_{k} ) + {\hat{δ}}_{CT}^{bias} {f}_{UL}}{2 {f}_{UL}} . \qquad ( Equation 15 )$$

The term \hat{δ}_{CT}^{bias} is the bias correction term added by the CT. This term is determined in conjunction with the UE bias correction, and is determined by the estimates \hat{δ}_{Ka},\hat{δ}_{RA}, and Δf_{CT} as provided by the CT. By substituting equations 14 and 7, the \tilde{δ}_{UE}(k) measurement may be written as:

Z_{δ}(k)=\tilde{δ}_{UE}(k)+\tilde{δ}^{bias}+v_{δ}(k). (Equation 16)

The term v_{δ}(k) is a sample-to-sample, random measurement noise, which may be defined as:

$${v}_{δ} ( k ) = \frac{1}{2} ( \frac{{ɛ}_{UE}^{freq} ( {t}_{k} - {τ}_{0} )}{{f}_{DL}} - \frac{{ɛ}_{CT}^{freq} ( {t}_{k} )}{{f}_{UL}} ) \qquad ( Equation 17 )$$

having variance

$${σ}_{δ}^{2} = var [ {Z}_{δ} ( k ) ] = \frac{1}{4} ( \frac{{σ}_{f , UE}^{2}}{{f}_{DL}^{2}} + \frac{{σ}_{f , CT}^{2}}{{f}_{UL}^{2}} ) , \qquad ( Equation 18 )$$

where σ_{f,UE}² and σ_{f,CT}² are the UE and CT frequency estimation variances, respectively. This noise process is random across UEs. The bias term in Equation 16 may be defined as:

$${\tilde{δ}}^{bias} = \frac{1}{2} ( \frac{Δ f}{{f}_{DL}} + {δ}_{Ka} + {δ}_{RA} - ( {\hat{δ}}_{UE}^{bias} + {\hat{δ}}_{CT}^{bias} ) ) . \qquad ( Equation 19 )$$

Again, this error is common to all UEs.

Referring again to FIG. 4, the method iterates as shown. More particularly, each of blocks 406 through 416 may be repeatedly performed and some of blocks 406 through 416 may be repeated in parallel with each other for transmissions of different data frames. The method of FIG. 4 may continue to be performed until the communication between the UE and the CT is terminated.

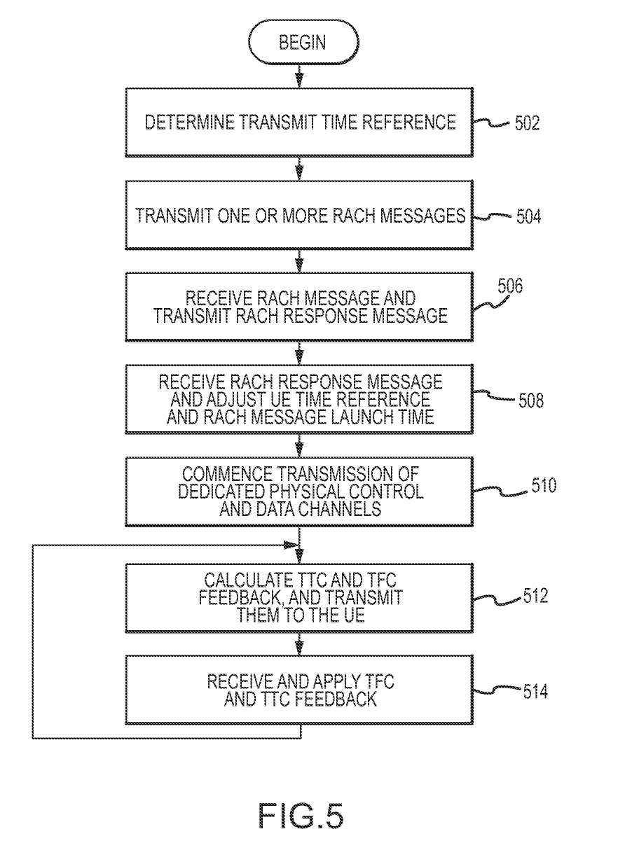

As indicated in the discussion of FIG. 4, the TTC and TFC is first initialized and then is updated during the communication between the UE and the CT. FIG. 5 is a flowchart of a method for initializing and updating TTC and TFC in a wireless communication system, according to an embodiment. More particularly, the embodiment illustrated and described in conjunction with FIG. 5 relates to TTC and TFC initialization through a sequence of messages exchanged over a RACH, and TTC and TFC updates performed through feedback provided over a dedicated channel (e.g., a DCCH or DPCCH). It is to be understood that, in other embodiments, TTC and TFC initialization and updates may be performed using other types of message exchanges and/or using other channels between a UE (e.g., UE 102, FIG. 1) and a CT (e.g., CT 106, FIG. 1). Accordingly, the below described, example embodiment, is not meant to limit the scope of the embodiments.

According to an embodiment, TTC and TFC initialization may begin, in block 502, by the UE determining an implicit transmit time reference, \hat{t}⁻(t). According to an embodiment, this includes the UE monitoring a pilot channel (e.g., a CPICH), and using strong Doppler correction to determine the transmit time reference. According to an embodiment, the transmit time reference approximately equals a time that a corrected UE clock reads at a CT reference time, t. Initially, the UE has not received any TTC or TFC feedback from the CT, and accordingly, the initial estimate of the UE clock error, \hat{δ}_{UE}(0), equals zero, and the transmit time reference, \hat{t}⁻(t), is skewed by the full UE clock error. However, the Doppler correction is running According to an embodiment, a constant bias correction term, \hat{δ}_{UE}^{biaS}, is provided over a control channel (e.g., a BCCH), and the constant bias correction term is used in determining the transmit time reference, \hat{t}⁻(t).

In block 504, the UE transmits one or more RACH messages, according to an embodiment. The time of launch of each RACH message is denoted \hat{t}_{RACH}⁻(i), relative to the transmit time reference, \hat{t}⁻(t), and where i is a RACH message index. Each RACH message includes the RACH message index, i, and the RACH message launch times are stored at the UE.

In block 506, the CT receives one of the RACH messages, and in response, transmits a RACH response message. According to an embodiment, the RACH response message includes the following (or equivalent) information: a) the RACH index, i, of the received RACH message; b) the time of arrival, t₀, of the received RACH message (e.g., System Frame Number (SFN), slot number, and sub-slot ToA), in CT reference time; c) the target first time of arrival, tₛₜₐᵣₜ, (at the CT) of the UE's dedicated channel (DCH) in CT reference time; and d) the initial TFC feedback, Δ_{TFC}(0) (and the constant bias correction term, \hat{δ}_{UE}^{bias}, when not contained in the BCCH).

In block 508, the UE receives the RACH response message, and in response, adjusts the UE's time reference and the RACH message launch time. According to an embodiment, the UE time reference is adjusted as follows:

\hat{t}⁺(t)=(1−\hat{δ}_{UE}(1))\hat{t}⁻(t), (Equation 20)

where \hat{δ}_{UE}(1)=Δ_{TFC}(0) (from the RACH response message). The UE time reference adjustment is applied to the running time variable at the time of reception of the RACH response message, according to an embodiment, and the RACH message launch time is adjusted as follows:

\hat{t}_{RACH}⁺(i)=(1−\hat{δ}_{UE}(1))\hat{t}_{RACH}⁻(i). (Equation 21)

Given the UE time reference and RACH message launch time adjustments, the UE commences transmission of its DPCCH and Dedicated Physical Data Channel (DPDCH), in block 510. According to an embodiment, transmission of the DPCCH and DPDCH is commenced at time:

\hat{t}_{Tx}⁺=\hat{t}_{RACH}⁺(i)+tₛₜₐᵣₜ−t₀. (Equation 22)

At this point, initialization of TFC and TTC may be considered to be completed. In accordance with the above-described procedure, it may be noted that the UE time offset, \hat{t}⁻(0)=\hat{t}⁺(0), relative to CT reference time may be considered to be irrelevant. The above procedure does not determine the propagation delay, τ₀. Instead, the procedure determines the required transmit start time relative to the UE's corrected clock.

Upon commencement of the DPCCH and DPDCH, TTC and TFC updates may be performed. According to an embodiment, TTC and TFC updates may be implemented as a closed loop system, as will be described below. In block 512, the CT calculates the TTC and TFC feedback for the instance k−1, and transmits the TTC and TFC feedback to the UE (e.g., via the DPCCH) at time tₖ₋₁.

In block 514, the UE receives and applies the TTC and TFC feedback at time tₖ₋₁+τ₀. Blocks 512 and 514 are thereafter continuously, periodically or occasionally repeated for a duration of transmission of the DPCCH and the DPDCH, according to an embodiment. Accordingly, during a second iteration, for example, the CT may make new ToA and UE clock error measurements during the time tₖ₋₁+2τ₀≦t≦tₖ, which may be used to calculate the kth instance of TTC and TFC feedback, according to an embodiment.

Although the description, above, indicates that certain processes are performed at the UE or the CT, it is to be understood that, in some instances, portions of the methods that are indicated to be performed by the CT or the UE may be interchangeable, in various other embodiments. It is to be understood that any given examples or references to a CT or a UE are not meant to limit the embodiments to the examples given. In addition, an entire set of signals that may be transmitted between a UE and a CT are not discussed herein.

Embodiments of methods and apparatus for performing transmission control in a wireless communication system have now been described. Implementation of these and other embodiments may enable capacity enhancing techniques to be employed in a communication system, including but not limited to an orthogonal UE-CT signal structure technique and a multi-user detection (MUD) technique.

An embodiment includes a method for performing transmission control in a communication system that includes a control terminal (CT), a relay apparatus (RA), and a plurality user equipment (UE) that wirelessly communicate with the CT through the RA. The method includes the CT receiving an RA-CT downlink signal that originated from a UE, determining a frequency-of-arrival (FoA) error from the RA-CT downlink signal (where the FoA error results at least in part from an error in a UE time reference with respect to a CT time reference), and providing, to the UE, a transmit frequency control (TFC) feedback signal that indicates the error in the UE time reference. The method also includes the UE producing an adjusted UE uplink carrier frequency signal that compensates for the error in the UE time reference as indicated in the TFC feedback signal, and upconverting and transmitting a UE-RA uplink signal using the adjusted UE uplink carrier frequency signal.

The foregoing detailed description is merely exemplary in nature and is not intended to limit the inventive subject matter or the application and uses of the inventive subject matter to the described embodiments. Furthermore, there is no intention to be bound by any theory presented in the preceding background or detailed description. Those of skill in the art will recognize, based on the description herein, that various other apparatus and processes may be included in embodiments of the systems and methods described herein for conditioning, filtering, amplifying, and/or otherwise processing the various signals. In addition, the sequence of the text in any of the claims does not imply that process steps must be performed in a temporal or logical order according to such sequence unless it is specifically defined by the language of the claim. The process steps may be interchanged in any order, and/or may be performed in parallel, without departing from the scope of the inventive subject matter. In addition, it is to be understood that information within the various different messages, which are described above as being exchanged between the system elements, may be combined together into single messages, and/or the information within a particular message may be separated into multiple messages. Further, messages may be sent by system elements in sequences that are different from the sequences described above. Furthermore, words such as “connected” or “coupled to” used in describing a relationship between different elements do not imply that a direct physical connection must be made between these elements. For example, two elements may be connected to each other physically, electronically, logically, or in any other manner, through one or more additional elements, without departing from the scope of the inventive subject matter.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled technicians may implement the described functionality in varying ways for each particular application, but such implementation decisions should not be interpreted as causing a departure from the scope of the inventive subject matter.

The various illustrative logical blocks and modules described in connection with the embodiments disclosed herein may be implemented or performed with various types of computational apparatus, including but not limited to, a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in one or more software modules executed by a processor, or in a combination of the two. A software module may reside in random access memory, flash memory, read only memory (ROM), erasable programmable ROM (EPROM), electrical EPROM, registers, hard disk, a removable disk, a compact disc ROM (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

While various exemplary embodiments have been presented in the foregoing detailed description, it should be appreciated that a vast number of variations exist. It should also be appreciated that the exemplary embodiments are only examples, and are not intended to limit the scope, applicability or configuration of the inventive subject matter in any way. Rather, the foregoing detailed description will provide those skilled in the art with a convenient road map for implementing various embodiments of the inventive subject matter, it being understood that various changes may be made in the function and arrangement of elements described in an exemplary embodiment without departing from the scope of the inventive subject matter as set forth in the appended claims and their legal equivalents.

What is claimed is:

1. A method for performing transmission control in a communication system that includes a control terminal (CT), a relay apparatus (RA), and a plurality user equipment (UE) that wirelessly communicate with the CT through the RA, the method comprising the steps of:
the CT receiving an RA-CT downlink signal that originated from a UE;
the CT determining a frequency-of-arrival (FoA) error from the RA-CT downlink signal, wherein the FoA error results at least in part from an error in a UE time reference with respect to a CT time reference;
the CT providing, to the UE, a transmit frequency control (TFC) feedback signal that indicates the error in the UE time reference;
the UE receiving the TFC feedback signal, and producing an adjusted UE uplink carrier frequency signal that compensates for the error in the UE time reference as indicated in the TFC feedback signal; and
the UE upconverting and transmitting a UE-RA uplink signal using the adjusted UE uplink carrier frequency signal.

2. The method of claim 1, further comprising:
the CT determining a time-of-arrival (ToA) error from the RA-CT downlink signal;
the CT sending a transmit time control (TTC) feedback signal to the UE that indicates the ToA error; and
the UE receiving the TTC feedback signal, and adjusting a UE transmit time to compensate for the ToA error indicated in the TTC feedback signal.

3. The method of claim 1, further comprising:
the RA receiving the UE-RA uplink signal and performing a frequency translation of the UE-RA uplink signal to generate an RA-CT downlink signal; and
the RA transmitting the RA-CT downlink signal on an RA-CT downlink between the RA and the CT.

4. The method of claim 3, wherein the frequency translation includes translating the UE-RA uplink signal at a UHF band frequency to an RA-CT downlink signal at a Ka band frequency.

5. The method of claim 1, further comprising:
the CT producing an adjusted CT uplink carrier frequency signal that compensates for a Doppler shift on an RA-CT downlink between the RA and the CT; and
the CT upconverting and transmitting a CT-RA uplink signal using the adjusted CT uplink carrier frequency signal.

6. The method of claim 1, further comprising:
the CT determining an error in an RA time reference with respect to the CT time reference;
the CT producing an adjusted CT uplink carrier frequency signal that compensates for the error in the RA time reference; and
the CT upconverting and transmitting a CT-RA uplink signal using the adjusted CT uplink carrier frequency signal.

7. The method of claim 1, further comprising:
the CT upconverting and transmitting a CT-RA uplink signal;
the RA receiving the CT-RA uplink signal and performing a frequency translation of the CT-RA uplink signal to generate an RA-UE downlink signal; and
the RA transmitting the RA-UE downlink signal on an RA-UE downlink between the RA and the UE.

8. The method of claim 7, further comprising:
the UE receiving the RA-UE downlink signal; and
the UE determining, using the RA-UE downlink signal, a Doppler estimate representative of a Doppler shift on the RA-UE downlink,
wherein the UE produces the adjusted UE uplink carrier frequency signal to compensate also for the Doppler shift on the RA-UE downlink.

9. The method of claim 8, wherein the UE determines the Doppler estimate based on a frequency estimation of a transmitted reference signal from the CT.

10. The method of claim 7, wherein the frequency translation includes translating the CT-RA uplink signal at a Ka band frequency to an RA-UE downlink signal at a UHF band frequency.

11. The method of claim 1, further comprising:
the UE adjusting a time base used to generate the UE-RA uplink signal to account for Doppler.

12. A method for performing transmission control in a communication system that includes a control terminal (CT), a relay apparatus (RA), and a plurality user equipment (UE) that wirelessly communicate with the CT through the RA, the method performed by a UE and comprising the steps of:
receiving a transmit frequency control (TFC) feedback signal from the CT, wherein the TFC feedback signal indicates an error in a UE time reference with respect to a CT time reference;
producing an adjusted UE uplink carrier frequency signal that compensates for the error in the UE time reference as indicated in the TFC feedback signal; and
upconverting and transmitting a UE-RA uplink signal using the adjusted UE uplink carrier frequency signal.

13. The method of claim 12, wherein producing the adjusted UE uplink carrier frequency signal comprises:
receiving, from a UE reference generator, a clock signal that is based on the UE time reference;
receiving a signal indicating the error in the UE time reference; and
producing the adjusted UE uplink carrier frequency signal by increasing or decreasing a UE uplink carrier frequency by a frequency delta that corresponds to the error in the UE time reference.

14. The method of claim 12, wherein producing the adjusted UE uplink carrier frequency signal comprises:
adjusting a frequency of a clock signal produced by a UE reference generator by a frequency delta that corresponds to the error in the UE time reference, in order to produce an adjusted clock signal; and
providing the adjusted clock signal to a carrier generator to be used as a basis for producing the adjusted UE uplink carrier frequency signal.

15. The method of claim 12, further comprising:
receiving a TTC feedback signal from the CT, wherein the TTC feedback signal indicates a time-of-arrival error at the CT of a signal that originated from the UE, and
adjusting a UE transmit time to compensate for the ToA error indicated in the TTC feedback signal.

16. The method of claim 12, further comprising:
the UE adjusting a time base used to generate the UE-RA uplink signal to account for Doppler.

17. The method of claim 12, further comprising:
the UE receiving an RA-UE downlink signal; and
the UE determining, using the RA-UE downlink signal, a Doppler estimate representative of a Doppler shift on the RA-UE downlink,
wherein the UE produces the adjusted UE uplink carrier frequency signal to compensate also for the Doppler shift.

18. The method of claim 17, wherein the UE determines the Doppler estimate based on a frequency estimation of a transmitted reference signal from the CT.

19. A method for performing transmission control in a communication system that includes a control terminal (CT), a relay apparatus (RA), and a plurality user equipment (UE) that wirelessly communicate with the CT through the RA, the method performed by a CT and comprising the steps of:
receiving an RA-CT downlink signal that originated from a UE;
determining a frequency-of-arrival (FoA) error from the RA-CT downlink signal, wherein the FoA error results at least in part from an error in a UE time reference with respect to a CT time reference; and
providing, to the UE, a transmit frequency control (TFC) feedback signal that indicates the error in the UE time reference, in order to enable the UE to produce an adjusted UE uplink carrier frequency signal that compensates for the error in the UE time reference as indicated in the TFC feedback signal.

20. The method of claim 19, further comprising:
determining a time-of-arrival (ToA) error from the RA-CT downlink signal; and
sending a transmit time control (TTC) feedback signal to the UE that indicates the ToA error, in order to enable the UE to adjust a UE transmit time to compensate for the ToA error indicated in the TTC feedback signal.

21. The method of claim 19, further comprising:
determining a first Doppler estimate representative of a Doppler shift on an RA-CT downlink between the RA and the CT;
determining an error in an RA time reference with respect to the CT time reference;
producing an adjusted CT uplink carrier frequency signal that compensates for the first Doppler estimate and the error in the RA time reference; and
upconverting and transmitting a CT-RA uplink signal using the adjusted CT uplink carrier frequency signal.

22. A system comprising:
a relay apparatus (RA) adapted to exchange radio frequency (RF) signals between a control terminal (CT) and a user equipment (UE);
the CT adapted to
receive an RA-CT downlink signal that originated from the UE,
determine a frequency-of-arrival (FoA) error from the RA-CT downlink signal, wherein the FoA error results at least in part from an error in a UE time reference with respect to a CT time reference, and
provide, to the UE, a transmit frequency control (TFC) feedback signal that indicates the error in the UE time reference; and
the UE adapted to
receive the TFC feedback signal,
produce an adjusted UE uplink carrier frequency signal that compensates for the error in the UE time reference as indicated in the TFC feedback signal, and
upconvert and transmit a UE-RA uplink signal using the adjusted UE uplink carrier frequency signal.

23. The system of claim 22, wherein the RA is adapted to exchange the RF signals by:
receiving first signals from the CT;
performing a first frequency translation on the first signals to produce second signals;
transmitting the second signals toward the UE;
receiving third signals from the UE;
performing a second frequency translation on the third signals to produce fourth signals; and
transmitting the fourth signals toward the CT.

24. The system of claim 23, wherein the first frequency translation includes converting the first signals from a Ka band to a UHF band, and wherein the second frequency translation includes converting the third signals from the UHF band to the Ka band.

25. The system of claim 22, wherein the RA is borne by a satellite.
